(19) United States
(12) Patent Application Publication
(10) Pub. No.: US 2021/0358055 A1
(43) Pub. Date: Nov. 18, 2021

(54) METHODS AND SYSTEMS FOR PROVIDING ADVICE

(71) Applicant: Megdad Zaatreh, East Brunswick, NJ (US)

(72) Inventor: Megdad Zaatreh, East Brunswick, NJ (US)

(21) Appl. No.: 17/318,147

(22) Filed: May 12, 2021

Related U.S. Application Data
(60) Provisional application No. 63/023,639, filed on May 12, 2020.

(51) Int. Cl. G06Q 50/00; G06Q 30/02; G06F 16/9536; G06F 16/28; G06F 16/9538; G06F 16/9535; G06F 3/0482; H04L 12/58

(52) U.S. Cl. CPC G06Q 50/01; G06Q 30/0201; G06Q 30/0282; G06F 16/9536; H04L 51/32; G06F 16/9538; G06F 16/9535; G06F 3/0482; G06F 16/285

(57) ABSTRACT

Methods and systems for providing advice are described. An advice request is received via a social media platform from a user. The user selects categories associated with the advice request and criteria associated with influencers to respond to the advice request. The social media platform queries a database of the influencers, where the database includes profiles associated with the influencers and where each profile comprises a subset of the categories and a subset of the criteria. The user selected categories are compared to the subset of the categories in the profiles and the user selected criteria are compared to the subset of the criteria in the profiles to identify matches with a first profile of a first influencer and a second profile of a second influencer. The user selects the first influencer to respond to the advice request. The first influencer responds, in real-time, to the advice request.

### CROSS REFERENCE TO RELATED APPLICATION

This application is a non-provisional application of U.S. Application No. 63/023,639 filed May 12, 2020. The disclosure of which is incorporated herein by reference.

### FIELD OF THE EMBODIMENTS

The field of the invention and its embodiments relate to methods and systems for providing advice. In particular, the instant invention relates to methods and systems for receiving fashion and/or life advice from influencers or “experts” in particular categories (e.g., footwear, attire, accessories, relationships, careers, goals, etc.) based on user-selected criteria (e.g., an age of the expert, a geographic location of the expert, a gender of the expert, a popularity or expertise status of the expert, etc.).

### BACKGROUND OF THE EMBODIMENTS

Regardless of ones gender, age, clothing size, or socio-economic status, individuals are constantly judged by their outward appearance. However, in today's fast paced society, individuals rarely have time to scower through their closet to effortlessly make fashion decisions quickly that are appropriate for particular circumstances. For example, a woman may work a full-time job as an accountant and may also be a single mother of three children. After work, she may not have any time left in her day to find an outfit appropriate for a business meeting. As another example, a man may be a recent college graduate who is interviewing for numerous positions. He may be unable to afford a new tie and may be unsure of how to match the ties in his closet with a suit for one such interview. As a further example, a grandmother may be attending her granddaughter's wedding and may be unsure of what footwear matches a dress she is planning to wear. Current solutions in the field fail to alleviate this problem, and additionally, cannot be applied realistically.

Thus, a need exists for methods and/or systems that take the guesswork out of finding a coordinated outfit for a particular occasion. In particular, a need exists for a method and/or a system that allows individuals to quickly receive fashion advice from “experts” in particular categories (e.g., attire, accessories, footwear, etc.) based on user-selected criteria (e.g., an age of the expert, a geographic location of the expert, a gender of the expert, a popularity or expertise status of the expert, etc.). Additionally, a further need exists for a method and/or a system that allows individuals to quickly receive life advice from “experts” in particular categories (e.g., relationships, careers, friendships, etc.) based on the user-selected criteria.

### Review of Related Technology

U.S. Pat. No. 10,354,302 B2 describes use of a fashion application or tool to easily and readily receive fashion advice based on stored images of a user's wardrobe and/or from images retrieved from clothing retailers. The advice may be communicated to the user via one or more fashion avatars, or by a linked fashion consultant or through the users involvement in virtual fashion shows.

U.S. Published Patent Application No. 2012/0226521 A describes a method to: (1) access one or more experts and one or more influencers identified for a subject matter, where the one or more experts and the one or more influencers are among one or more users of a social-networking system; and (2) invite a first expert and a second expert to establish a first social connection within the social-networking system.

JP 2008/108287 A describes inputting physical characteristics into a device to receive fashion content or advice as an output from the device.

JP 2015/026190 A describes a clothing advice system capable of coordinating clothing with an advisor that suits the user's preference.

JP 6,199,685 B2 describes a fashion coordination assist device that provides fashion coordination automatically that reflects a preference of a user. The fashion coordination assist device includes: (1) a product information obtaining unit to obtain product information via a communication line; (2) a coordination information providing unit to provide coordination information representing a combination of products to be worn by a user on the basis of the product information obtained by the product information obtaining unit; (3) a user information obtaining unit to obtain user information via the communication line; and (4) a tendency information generating unit to estimate a fashion tendency of the user on the basis of the user information obtained by the user information obtaining unit and generate tendency information representing a tendency of fashion of the user.

U.S. Published Patent Application No. 2012/0226748 A1 describes a method that includes: assessing a set of information relating to a subject matter, where the set of information has been shared among one or more users of a social-networking system. For each element of information, the method then determines a rate of sharing of the element of information among the one or more users and identifies one or more first users who cause the rate of sharing of the element of information to increase. Next, the method identifies one or more influencers associated with the subject matter from the one or more first users identified for each element of information.

Various methods and systems exist in the art. However, their means of operation are substantially different from the present disclosure, as the other inventions fail to solve all the problems taught by the present disclosure.

### SUMMARY OF THE EMBODIMENTS

The present invention and its embodiments relate to methods and systems for providing advice. In particular, the instant invention relates to methods and systems for receiving fashion and/or life advice from influencers or “experts” in particular categories (e.g., footwear, attire, accessories, relationships, careers, goals, etc.) based on user-selected criteria (e.g., an age of the expert, a geographic location of the expert, a gender of the expert, a popularity or expertise status of the expert, etc.).

A first embodiment of the present invention describes a computer system. The computer system includes one or more processors, one or more memories, and one or more computer-readable hardware storage devices. The one or more computer-readable hardware storage devices contain program code executable by the one or more processors via the one or more memories to implement a method for providing fashion and/or life advice to a user. The method includes numerous process steps, such as: receiving, via a social media platform and from the user associated with a computing device, an advice request. The user may be submitting the advice request to benefit the user or to benefit another user.

The method may further include: prompting, via the social media platform, the user to select categories associated with the advice request and criteria associated with influencers to respond to the advice request. The categories associated with the advice request may include: a hairstyle category, an accessory category, an attire category, a footwear category, a relationship category, a makeup category, a friendship category, a career category, and/or a goal category, among others. The criteria associated with the influencers to respond to the advice request include: an age of the influencer, a gender of the influencer, a geographic location of the influencer, and/or an expertise status associated with the influencer, among others. It should be appreciated that the specific categories and criteria listed herein are non-exhaustive and other categories and/or criteria are contemplated. Next, the method may include: receiving, via the social media platform and from the user, the selection of at least one of the categories and the selection of at least one of the criteria.

The method may then include: querying, via the social media platform, a database of the influencers. Each of the influencers in the database may be associated with a profile. For example, a first profile may be associated with a first influencer and a second profile may be associated with a second influencer. Further, each of the first profile and the second profile may comprise a subset of the categories and a subset of the criteria.

The method may further include: comparing, via the social media platform, the at least one of the categories selected by the user to the subset of the categories for each of the first profile and the second profile. The social media platform may then identify a match between the at least one of the categories selected by the user and the subset of the categories for the first profile and the second profile. The method may additionally include: comparing, via the social media platform, the at least one of the criteria selected by the user to the subset of the criteria for the first profile and the second profile. The social media platform may then identify another match between the at least one of the criteria and the subset of the criteria for the first profile and the second profile.

The social media platform may then display the first profile and the second profile to the user. The user may select the first influencer (associated with the first profile) to respond to the advice request. The social media platform may prompt the first influencer to respond to the advice request. In response to receiving, via the social media platform and from the first influencer, the response to the advice request, the response may be displayed to the user.

In response to failing to receive, via the social media platform and from the first influencer, the response to the advice request, the social media platform may prompt the second influencer (associated with the second profile) to respond to the advice request. Upon receiving, via the social media platform and from the second influencer, the response to the advice request, the social media platform may display the response to the user. The response to the advice request from the first or the second influencer is received via instantaneous and real-time feedback that may include a video component, an audio component, a textual component, and/or a graphical component, among others.

The social media platform may then receive the payment for the response to the advice request from the user. Upon receiving the payment, the social media platform may transmit at least a portion of the payment to the first or the second influencer, based on which influencer responded to the advice request. A portion of the payment may also be submitted to the social media platform for use of the platform.

A second embodiment of the instant invention describes a method for providing fashion and/or life advice. The method includes numerous process steps, such as: receiving, via the social media platform and from the user, the advice request associated with the fashion and/or life advice; prompting, via the social media platform, the user to select at least one category associated with the advice request and a predetermined expertise status associated with influencers to respond to the advice request; receiving, via the social media platform and from the user, the selected category and the predetermined expertise status; and querying, via the social media platform, the database of the influencers. It should be appreciated that the predetermined expertise status associated with influencers to respond to the advice request is set by the user.

The database of influencers includes the first profile associated with the first influencer and the second profile associated with the second influencer. The first profile comprises a subset of the categories and a first expertise status associated with the first influencer. The second profile comprises another subset of the categories and a second expertise status associated with the second influencer. The first expertise level associated with the first influencer is greater than the second expertise level associated with the second influencer.

The social media platform may compare the at least one category selected by the user to the subset of the categories of the first profile and may identify a match. The social media platform may also compare the at least one category selected by the user to the other subset of the categories of the second profile and may identify another match.

The social media platform may further compare the predetermined expertise status set by the user to the first expertise status associated with the first influencer (of the first profile) and the second expertise status associated with the second influencer (of the second profile). The social media platform may identify the first expertise status as exceeding the predetermined expertise status set by the user. Moreover, the social media platform may identify the second expertise status associated with the second influencer as failing to exceed the predetermined expertise status set by the user. In response, the social media platform may then display the first profile to the user.

The social media platform may also prompt the first influencer to respond to the advice request; receive, from the first influencer, the response to the advice request; and display the response to the user. The social media platform may also receive, from the user, payment for the response to the advice request. Upon receiving the payment, the social media platform may transmit at least a portion of the payment to the first influencer. A portion of the payment may also be submitted to the social media platform for use of the platform.

The social media platform may further receive feedback from the user based on the advice request. The feedback may include a numerical rating of the first influencer and at least the video component, the audio component, the textual component, and/or the graphical component. The numerical rating of the first influencer correlates to the quantity of points. The social media platform may further be configured to: increase the first expertise status of the first influencer based on the quantity of points; update the first profile of the first influencer based on the modified first expertise status of the first influencer; and transmit the updated first profile to the database.

A third embodiment of the instant invention describes a method for providing fashion advice. The method includes numerous process steps, such as: receiving, via the social media platform and from the user, the advice request associated with the fashion advice for another user; prompting, via the social media platform, the user to select at least one category associated with the advice request (e.g., hairstyles, accessories, attire, and/or footwear, etc.) and at least one criteria associated with influencers to respond to the advice request; receiving, via the social media platform and from the user, the selection of the at least one category and the at least one criteria; and querying, via the social media platform, a database of the influencers. The database of influencers comprises the first profile and the second profile associated with the first and the second influencer, respectively.

The social media platform may compare the at least one category selected by the user to the subset of the categories of the first and the second profile. The social media platform may identify a match between the at least one category selected by the user and the subset of the categories associated with the first and the second profile. The social media platform may also compare the at least one criteria selected by the user to the subset of the criteria of the first and the second profile. The social media platform may identify a match between the at least one criteria selected by the user and the subset of the criteria of the first and the second profile.

The social media platform may then display the first profile and the second profile to the user; receive a selection of the first influencer to respond to the advice request; prompt the first influencer to respond to the advice request; receive, from the first influencer, the response to the advice request in real-time; and display the response to the other user. The social media platform may also receive, from the user, payment for the response to the advice request. Upon receiving the payment, the social media platform may transmit at least a portion of the payment to the first influencer. A portion of the payment may also be submitted to the social media platform for use of the platform.

The method may additionally include: receiving real-time feedback from the other user based on the advice request. The real-time feedback comprises the numerical rating of the first influencer and at least one of the video component, the audio component, the textual component, and/or the graphical component, among others. The numerical rating of the first influencer correlates to the quantity of points. The social media platform may then: increase the expertise status of the first influencer based on the quantity of points; update the first profile of the first influencer based on the modified first expertise status of the first influencer; and transmit the updated first profile to the database.

In general, the present invention succeeds in conferring the following benefits and objectives.

It is an object of the present invention to provide a method and a system for providing advice.

It is an object of the present invention to provide a method and a system for providing fashion and/or life advice.

It is an object of the present invention to provide a method and a system for providing fashion and/or life advice in real-time to a user.

It is an object of the present invention to provide a method and a system for providing fashion advice that takes the guesswork out of finding a coordinated outfit for a particular occasion.

It is an object of the present invention to provide a method and a system for providing fashion and/or life advice in real-time from an “expert” or an influencer” in particular categories (e.g., attire, accessories, footwear, relationships, friendships, careers, etc.) based on user-selected criteria (e.g., an age of the expert, a geographic location of the expert, a popularity or expertise status of the expert).

### BRIEF DESCRIPTION OF THE DRAWINGS

FIG. 1 depicts a block diagram of a system configured to implement a method for providing advice, in accordance with embodiments of the present invention.

FIG. 2 depicts a block diagram of influencer profiles displayed via a social media platform, in accordance with embodiments of the present invention.

FIG. 3 depicts another block diagram of a response from an influencer on a social media platform, in accordance with embodiments of the present invention.

FIG. 4 depicts another block diagram of an updated influencer profile displayed via a social media platform subsequent receiving feedback from a user, in accordance with embodiments of the present invention.

FIG. 5 is a block diagram of a computing device included within the system of FIG. 1 that is configured to implement a method for providing advice, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As defined herein, “social media” comprises interactive computer-mediated technologies that facilitate the creation or sharing of information, ideas, career interests, and other forms of expression via virtual communities and networks.

As defined herein, a “social platform” is a web-based technology that enables the development, deployment, and management of social media solutions and services. The “social platform” additionally provides the ability to create social media websites and services with complete social media network functionality.

As defined herein, a “social networking service” may be referred to as a social networking website or a social networking platform. People may use the “social networking service” to build social networks or social relationship with other people who share similar personal or career interests, activities, backgrounds, or real-life connections.

As defined herein, a “social media influencer” is a user on social media who has established credibility in a specific industry. A “social media influencer” has access to a large audience and can persuade others by virtue of their authenticity and reach.

As defined herein, a “micro-influencer” is a user deemed to have an audience within a follower range of 2,000 followers up until about 50,000 followers on a particular social media channel.

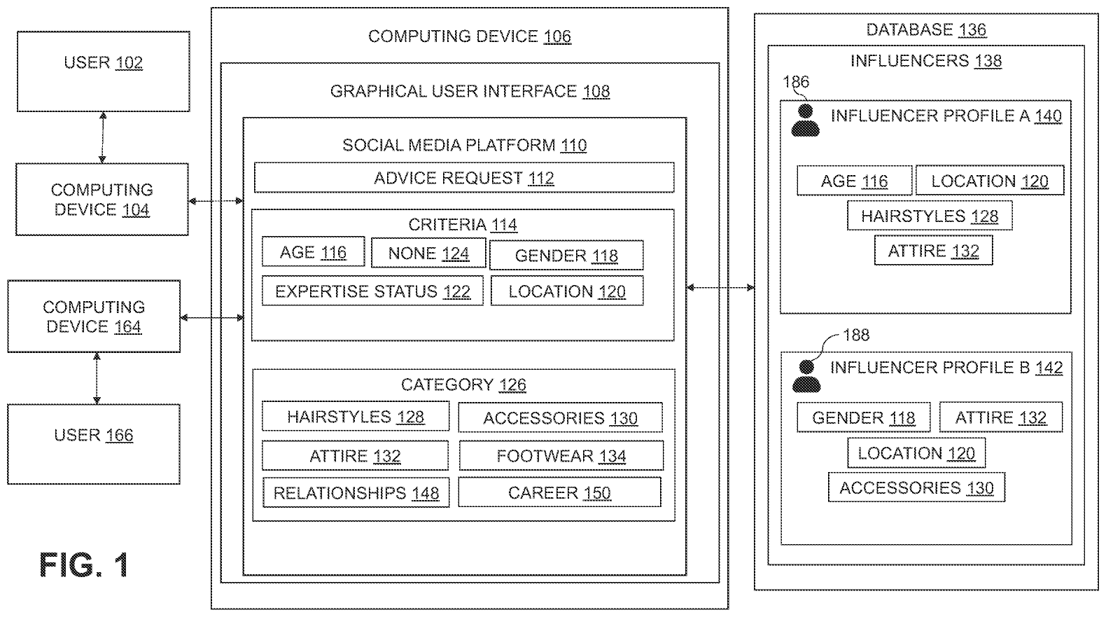

A system configured to implement a method for providing advice is depicted at least in FIG. 1. As shown in FIG. 1, the system includes a first computing device 104, a second computing device 106, and optionally a third computing device 164. Each of the first computing device 104, the second computing device 106, and the third computing device 164 (if included) may be a computer, a laptop computer, a smartphone, and/or a tablet, among other examples not explicitly listed herein. The first computing device 104 may be associated with a first user 102 and the third computing device 164 (if included) may be associated with a second user 166.

The second computing device 106 may include a social media platform 110. In other examples, the social media platform 110 of FIG. 1 may be a social media application, a social media engine, a social media software program, or a social media service, configured to be executable on the computing device 106. In general, the social media platform 110 facilitates and enables participants (e.g., the first user 102) to receive feedback and opinions from influencers 138 (e.g., “experts” in categories 126) about fashion advice (e.g., clothing style options, the general look of other participants (e.g., the third user 166), and/or about a specific item of clothing of the first user 102) and/or life advice.

The first user 102, each of the influencers 138, and/or the third user 166 (if present) may interact with the social media platform 110 via a graphical user interface (GUI) 108 on the second computing device 106. In an example, the social media platform 110 may receive, from the first user 102, each of the influencers 138, and/or the third user 166 (if present) login credentials. The login credentials may include a username, a password, a biometric identification means (e.g., fingerprint identification, face recognition identification, palm print identification, iris recognition, retina recognition, etc.), etc. In response, the social media platform 110 may identify the first user 102, each of the influencers 138, and/or the third user 166 (if present) based on the login credentials.

Identification of the first user 102, each of the influencers 138, and/or the third user 166 (if present) may include information such as: a name of the first user 102, a telephone number of the first user 102, and/or an address of the first user 102, etc. Identification of the first user 102, each of the influencers 138, and/or the third user 166 (if present) may additionally include determining if the first user 102, each of the influencers 138, and/or the third user 166 (if present) is associated with a profile on the social media platform 110.

If it is determined that the first user 102, each of the influencers 138, and/or the third user 166 (if present) does not yet have the profile, the social media platform 110 may prompt the first user 102, each of the influencers 138, and/or third user 166 (if present) to create such profile. Responsive to creation of such profile, the social media platform 110 may grant the first user 102, each of the influencers 138, and/or the third user 166 (if present) access to the social media platform 110. If it is determined that the first user 102, each of the influencers 138, and/or the third user 166 (if present) is associated with the profile, the social media platform 110 may grant the first user 102, each of the influencers 138, and/or the third user 166 (if present) access to the social media platform 110.

In an example, the social media platform 110 may receive, from the first user 102, an advice request 112. The advice request 112 may be associated with fashion advice and/or life advice. Moreover, the advice request 112 may be posed as a general or a specific question. For example, the advice request 112 may include a question, such as: “does my attire match?,” “does my tie match this suit?,” “does this necklace match my dress?,” “can I wear this hat with this outfit?,” “should I wear a jacket with this outfit?,” “should I wear natural makeup with this outfit?,” “what is the best suit for a job interview?,” etc. In a first example, the first user 102 may select the advice request 112 to benefit the first user 102. In a second example, the first user 102 may select the advice request 112 to benefit the second user 166.

In response, the social media platform 110 may prompt the first user 102 to select categories 126 associated with the advice request 112 and criteria 114 associated with the influencers 138 to respond to the advice request 112. The first user 102 need only select one of the categories 126 and one of the criteria 114. However, a quantity of the categories 126 and/or the criteria 114 selected by the user 102 is non-limiting.

In examples, the categories 126 associated with the advice request 112 may include: a hairstyles category 128, an accessories category 130, an attire category 132, a footwear category 134, a relationships category 148, a career category 150, a makeup category (not shown), a friendships category (not shown), and/or a goals category (not shown), among other not explicitly listed herein.

The first user 102 may select the hairstyles category 128 if the first user 102 is inquiring about: popular haircuts, popular hair colors, how to style ones hair for an occasion, how to style ones hair based on ones face shape, how to style ones hair based on one's age, popular hairstyles for a season, and/or hairstyles based on one's sex, among others. The first user 102 may select the accessories category 130 if the first user 102 is inquiring about: glasses, sunglasses, jewelry, gloves, scarves, earmuffs, handbags, boots, bowties, headbands, and/or umbrellas, among others. The first user 102 may select the attire category 132 if the first user 102 is inquiring about: casual wear, business casual wear, semi-formal wear, formal wear, smart casual wear, cocktail wear, black tie wear, black tie optional wear, creative black tie wear, business wear, festive wear, and/or casual dressy wear, among others. The first user 102 may select the footwear category 134 if the first user 102 is inquiring about: boots, sandals, shoes, slippers, specific footwear (e.g., high-heeled footwear, climbing shoes, safety footwear, ski boots, snow shoes, ballet shoes, etc.), traditional footwear, and/or socks, among others.

The first user 102 may select the relationships category 148 to address any sort of relationship issue, such as: trust, self-respect, openness, and/or passion, among others. The first user 102 may select the career category 150 to address any sort of career issue, such as: how to climb the career ladder, how to impress your boss at work, how to take the next step to achieving a dream career, and/or how to handle difficult co-workers, among others. The first user 102 may select the makeup category (not shown) to address any questions related to makeup, including: application of makeup and/or types of makeup (e.g., face primers, concealers, foundations, blushes, highlighting creams, mascaras, eye shadows, lip balms, lip sticks, etc.). The first user 102 may select the friendships category (not shown) to address any sort of friendship issue, such as: loyalty, compassion, listening, etc. The first user 102 may select the goals category (not shown) to address any sort of goal issue, such as methods to achieving goals, how to overcome obstacles, how to get started to achieve a goal, etc.

The criteria 114 associated with the influencers 138 to respond to the advice request 112 may include: an age criteria 116 associated with an age of the influencer, a gender criteria 118 associated with a gender of the influencer, a geographic location criteria 120 associated with a geographic location of the influencer, and/or a predetermined expertise status criteria 122 associated with an expertise level of the influencer. The age criteria 116 of the influencer may include a specific age or an age range, such as: influencers between 21 and 31 years of age. The geographic location criteria 120 of the influencer may include: a listing of specific states (e.g., California) the influencer can reside in, a listing of cities (e.g., New York City or Los Angeles) the influencer can reside in, a listing of geographic regions of a country (e.g., the Northeast of the United States of America) the influencer can reside in, a listing of specific countries (e.g., the United States of America, England, or Germany) the influencer can reside in, etc. The predetermined expertise status criteria 122 of the influencer may include a base or bottom threshold expertise level, set by the first user 102, such that profiles associated with the influencers 138 who fall below the predetermined expertise status criteria 122 will not be displayed to the user 102 for selection to respond to the advice request 112.

The social media platform 110 may then receive from the first user 102 the selection of one or more of the categories 126 and one or more of the criteria 114. A quantity of the selected categories 126 and the selected criteria 114 is not limiting. In an illustrative example, the first user 102 may select the attire category 132 from the categories 126 and may select the location criteria 120 from the criteria 114.

Then, the social media platform 110 may query a database 136 of the influencers 138. The database 136 of the influencers 138 may include profiles associated with the influencers 138. For example, the database 136 of the influencers 138 may include an influencer profile A 140 associated with the first influencer 186 and an influencer profile B 142 associated with the second influencer 188.

As explained, each of the influencers 138 are considered “experts” regarding at least one of the categories 126. However, it should be appreciated that each of the influencers 138 may be associated with a differing level of expertise regarding the at least one of the categories 126. For example, both a first influencer 186 and a second influencer 188 may be considered an “expert” regarding the attire category 132. However, the first influencer 186 may have a higher expertise as compared to the second influencer 188 in this category.

Each of the profiles (e.g., the influencer profile A 140 associated with the first influencer 186 and/or the influencer profile B 142 associated with the second influencer 188) comprises a subset of the categories 126 and a subset of the criteria 114. For example, the influencer profile A 140 may include the following subset of the categories 126: the attire category 132 and the hairstyles category 128. The influencer profile A 140 may include the following subset of the criteria 114: the age criteria 116 and the location criteria 120. The influencer profile B 142 may include the following subset of the categories 126: the attire category 132 and the accessories category 130. The influencer profile B 142 may include the following subset of the criteria 114: the location criteria 120 and the gender criteria 118.

Next, the social media platform 110 may compare the categories 126 selected by the first user 102 (e.g., the attire category 132) with the subset of the categories 126 associated with each of the profiles (e.g., the influencer profile A 140 and the influencer profile B 142). Since the influencer profile A 140 and the influencer profile B 142 both include the attire category 132, the social media platform 110 may identify a match between the user selected category 126 (e.g., the attire category 132) and the influencer profile A 140 and may also identify a match between the user selected category 126 (e.g., the attire category 132) and the influencer profile B 142.

The social media platform 110 may also compare the criteria 114 selected by the first user 102 (e.g., the location criteria 120) with the subset of the criteria 114 associated with each of the profiles (e.g., the influencer profile A 140 and the influencer profile B 142). Since the influencer profile A 140 and the influencer profile B 142 both include the location criteria 120, the social media platform 110 may identify a match between the user selected criteria 114 (e.g., the location criteria 120) and the influencer profile A 140 and may also identify a match between the user selected criteria 114 (e.g., the location criteria 120) and the influencer profile B 142.

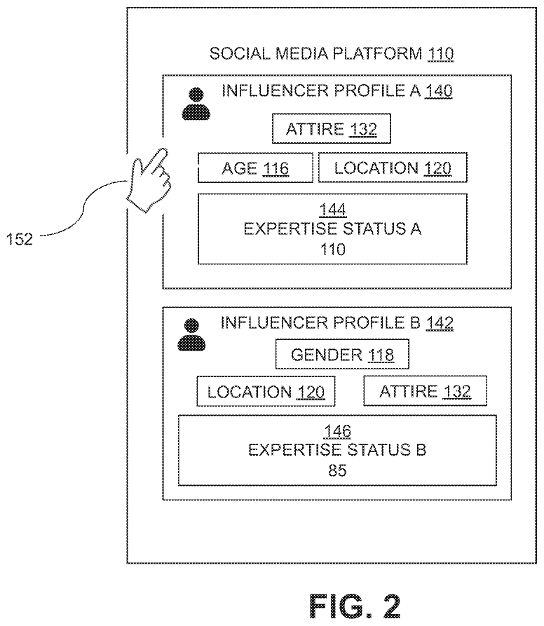

The social media platform 110 may then display the influencer profile A 140 and the influencer profile B 142 to the first user 102. Next, the social media platform 110 may receive, from the first user 102, a selection 152 of the influencer profile A 140 associated with the first influencer 186 to respond to the advice request 112 (as depicted in FIG. 2). The social media platform 110 may then prompt the first influencer 186 to respond to the advice request 112.

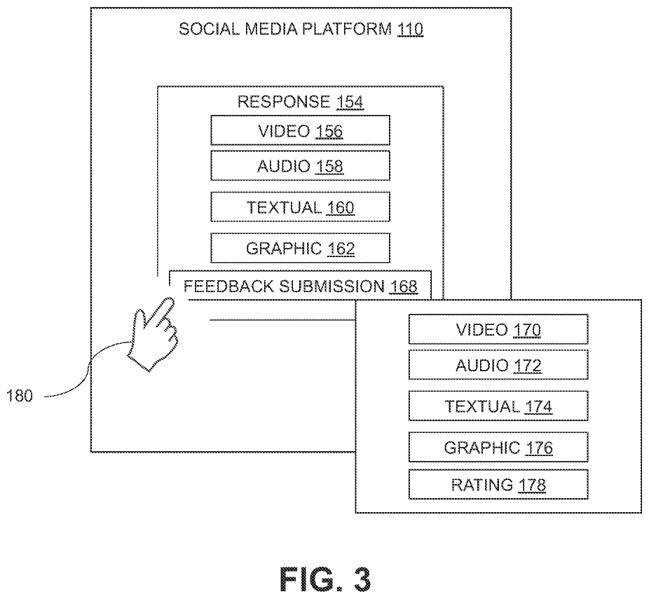

In response to receiving, via the social media platform 110 and from the first influencer 186, a response 154 to the advice request 112 (as depicted in FIG. 3), the response 154 may be displayed to the first user 102 or the second user 166, based on which user the response 154 is designated to benefit. In response to failing to receive, via the social media platform 110 and from the first influencer 186, the response 154 to the advice request 112, the social media platform 110 may prompt the second influencer 188 to respond to the advice request 112. The social media platform 110 may then receive, from the second influencer 188, the response 154 to the advice request 112. The response may then be displayed to the first user 102 or the second user 166, based on which user the response 154 is designated to benefit.

As depicted in FIG. 3, the response 154 to the advice request 112 from the first influencer 186 or the second influencer 188 is received as instantaneous and real-time feedback. The feedback may include: a video component 156 (e.g., a real-time video stream), an audio component 158, a textual component 160, and/or a graphical component 162 (e.g., a photograph of the first influencer 186 or the second influencer 188), among others. As an illustrative example, the response 154 to the advice request 112 may include an instantaneous live video stream where the first influencer 186 may view attire and/or a wardrobe of the first user 102, assess the attire and/or the wardrobe of the first user 102, and provide assistance to the first user 102 in choosing accessories to match a particular outfit.

Next, the social media platform 110 may then receive payment, from the first user 102 (since the first user 102 submitted the advice request 112), for the response 154 to the advice request 112 and may transmit at least a portion of the payment to the first influencer 186 or the second influencer 188, based on which influencer submitted the response 154 to the advice request 112. Another portion of the payment may be kept by the social media platform 110.

Additionally, subsequent to receiving the response 154 to the advice request 112 from the first influencer 186 or the second influencer 188, the first user 102 or the second user 166 (based on which user the response 154 is designated to benefit) may submit 180 feedback 168 to the response 154 (as depicted in FIG. 3). The feedback 168, as depicted in FIG. 3, may include a numerical rating 178 of the first influencer 186 or the second influencer 188 (based on who responded to the advice request 112) and a video component 170, an audio component 172, a textual component 174, and/or a graphical component 176, among others.

In an example, the feedback 168 to the response 154 from the first user 102 or the second user 166 (based on which user the response 154 is designated to benefit) may be saved in the influencer profile A 140 associated with the first influencer 186 or the influencer profile B 142 associated with the second influencer 188, based on which influencer responded to the advice request 112. The updated influencer profile A 140 or the updated influencer profile B 142 may be saved in the database 136. In some examples, the feedback 168 from the first user 102 or the second user 166 may be visible to other users when the updated influencer profile A 140 or the updated influencer profile B 142 is displayed via the social media platform 110.

In another example, the social media platform 110 may receive, from the first user 102, the advice request 112 for the first user 102. The social media platform 110 may prompt the first user 102 to select the category 126 associated with the advice request 112 and a predetermined expertise status 122 (of the criteria 114) associated with influencers 138 to respond to the advice request 112. The social media platform 110 may receive, from the first user 102, the selected category (e.g., the attire category 132) and the predetermined expertise status 122.

Then, the social media platform 110 may query the database 136 of the influencers 138. In an illustrative example and as depicted in FIG. 2, the influencer profile A 140 may be associated with the attire category 132 and may be associated with the following subset of the criteria 114: the age criteria 116, the location criteria 120, and an expertise status A 144 (for the attire category 132). As depicted in FIG. 2, the influencer profile B 142 may be associated with the attire category 132 and may be associated with the following subset of the criteria 114: the gender criteria 118, the location criteria 120, and an expertise status B 146 (for the attire category 132).

The expertise status for each of the influencers 138 is determined through a point system. In examples, the expertise status A 144 (of FIG. 2) may be displayed on the influencer profile A 140 and the expertise status B 146 (of FIG. 2) may be displayed on the influencer profile B 142 as an alphanumeric number (e.g., a status rating of 100), a fraction (e.g., a status ranking of 6/10), a graphic (e.g., three stars out of five stars), etc.

As displayed in FIG. 2, the expertise status A 144 and the expertise status B 146 may be displayed as the alphanumeric number. In a first example, and as depicted in FIG. 2, the expertise status A 144 associated with the attire category 132 may be an expertise level of 110 and the expertise status B 146 associated with the attire category 132 may be an expertise level of 85. In this example and as depicted in FIG. 2, the expertise status A 144 is greater than the expertise status B 146.

It should be appreciated that there are numerous ways for the first influencer 186 to increase the expertise status A 144 and for the second influencer 188 to increase the expertise status B 146. As a first example, the greater the positive feedback the first influencer 186 and/or the second influencer 188 receives from a user based on responding to advice requests, the higher the expertise status A 144 and/or the expertise status B 146 will be. As such, the more active the first influencer 186 and/or the second influencer 188 is on the social media platform 110, the higher the expertise status A 144 and/or the expertise status B 146 will be for a particular category. As a second example, the more popular the first influencer 186 and/or the second influencer 188 is on the social media platform 110, the higher the expertise status A 144 and/or the expertise status B 146 will be for a particular category. For example, if the first influencer 186 is received by users on the social media platform 110 as being funny and personable, the users are more likely to provide positive feedback to the first influencer 186 via the social media platform 110, thus resulting in a higher expertise status A 144 for a particular category. Thus, it follows that micro-influencers and celebrities will be associated with higher expertise statues for a particular category on the social media platform 110. The higher the expertise status for a particular category and associated with a particular influencer on the social media platform 110, the more likely a user on the social media platform 110 is to select that influencer to receive advice from in that specific category, and thus, the more the influencer may charge the user for responding to the advice request.

The social media platform 110 may compare the selected category (e.g., the attire category 132) to the subset of the categories associated with each of the influencer profile A 140 and the influencer profile B 142 to identify a match between the selected category (e.g., the attire category 132) and the subset of the categories associated with each of the influencer profile A 140 and the influencer profile B 142. The social media platform 110 may also compare the predetermined expertise status 122 to the expertise status A 144 of the influencer profile A 140 and the expertise status B 146 of the influencer profile B 142. As a result of the comparison, the social media platform 110 may identify that the expertise status A 144 of the influencer profile A 140 exceeds the predetermined expertise status 122 and that the expertise status B 146 of the influencer profile B 142 fails to exceed the predetermined expertise status 122. The social media platform 110 may display the influencer profile A 140 to the first user 102.

The social media platform 110 may then prompt the first influencer 186 (associated with the influencer profile A 140) to response to the advice request 112. The social media platform 110 may receive the response to the advice request 112 from the first influencer 186 and may display the response to the first user 102. The first user 102 may transmit the feedback 168 (of FIG. 3) to the social media platform 110. As explained, the feedback 168 may include the numerical rating 178 of the first influencer 186 and the video component 170, the audio component 172, the textual component 174, and/or the graphical component 176, among others. The numerical rating 178 of the first influencer 186 correlates to a quantity of points. In an example, the numerical rating 178 may be a rating of three, and as such, this correlates to three points.

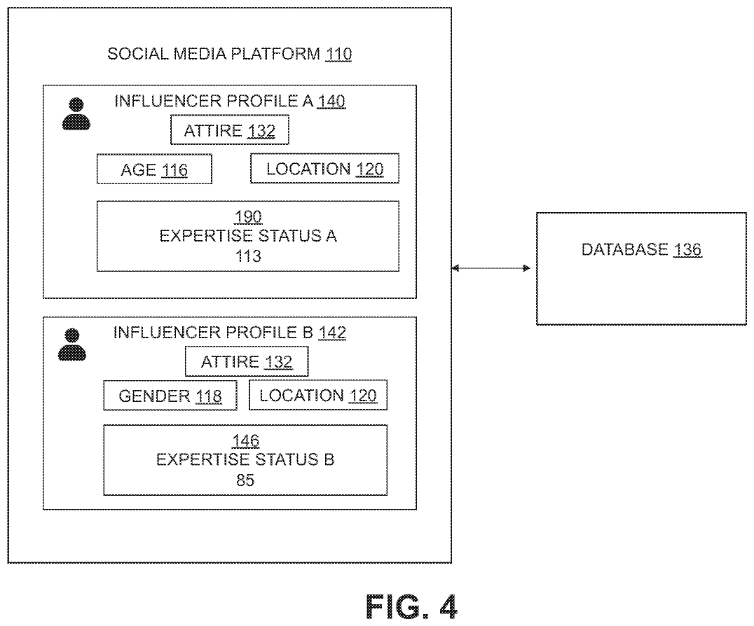

Upon receiving the feedback 168, and as depicted in FIG. 4, the social media platform 110 may increase the expertise status A 144 of the first influencer 186 by the quantity of points (e.g., three points) associated with the feedback 168. The social media platform 110 may also update the influencer profile A 140 based on a modified expertise status 190 (e.g., the expertise level of 113). Then, as depicted in FIG. 4, the social media platform 110 may transmit the modified influencer profile A 140 (containing the modified expertise status 190) to the database 136.

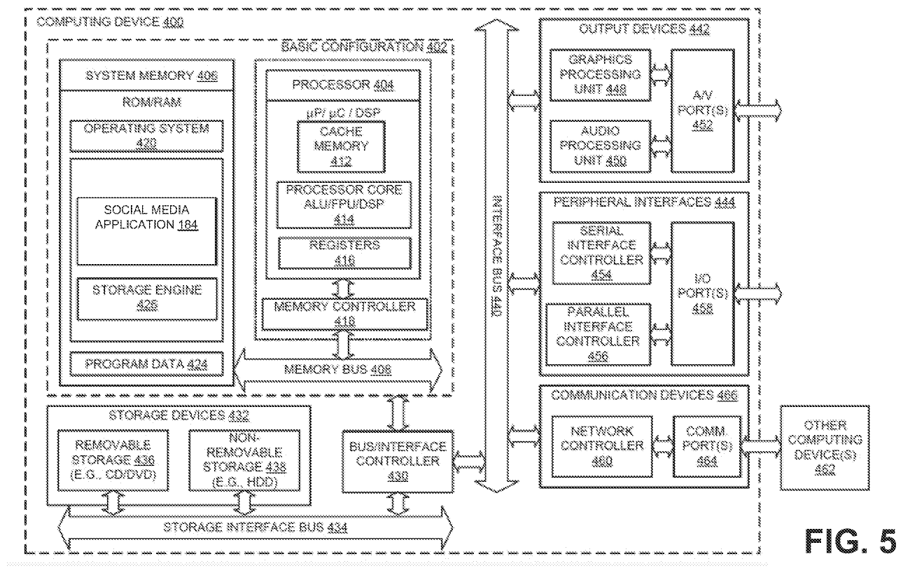

FIG. 5 is a block diagram of a computing device included within the system of FIG. 1 that is configured to implement a method for providing advice, in accordance with embodiments of the present invention. In some embodiments, the present invention may be a computer system, a method, and/or the computing device 106 (of FIG. 1) or the computing device 400 (of FIG. 5). For example, the computer system and/or the computing device 400 may be utilized to implement a method for providing advice.

A basic configuration 402 of a computing device 400 is illustrated in FIG. 4 by those components within the inner dashed line. In the basic configuration 402 of the computing device 400, the computing device 400 includes a processor 404 and a system memory 406. In some examples, the computing device 400 may include one or more processors and the system memory 406. A memory bus 408 is used for communicating between the one or more processors 404 and the system memory 406.

Depending on the desired configuration, the processor 404 may be of any type, including, but not limited to, a microprocessor (μP), a microcontroller (μC), and a digital signal processor (DSP), or any combination thereof. Further, the processor 404 may include one more levels of caching, such as a level cache memory 412, a processor core 414, and registers 416, among other examples. The processor core 414 may include an arithmetic logic unit (ALU), a floating point unit (FPU), and/or a digital signal processing core (DSP Core), or any combination thereof. A memory controller 418 may be used with the processor 404, or, in some implementations, the memory controller 418 may be an internal part of the memory controller 404.

Depending on the desired configuration, the system memory 406 may be of any type, including, but not limited to, volatile memory (such as RAM), and/or non-volatile memory (such as ROM, flash memory, etc.), or any combination thereof. The system memory 406 includes an operating system 420, one or more engines, such as a social media application 184, and program data 424. In some embodiments, the social media application 184 may be a social media engine, a social media software program, a social media service, or a social media software platform, as described infra. Moreover, in additional examples, the social media application 184 may comprise one or more algorithms to assist in the method for providing advice.

The social media application 184 may be configured to execute the method for providing advice. To do so, the social media application 184 may execute numerous process steps. For example, the social media application 184 may receive, from the first user 102, the advice request 112 and may prompt the first user 102 to select the categories 126 associated with the advice request 112 and the criteria 114 associated with the influencers 138 to respond to the advice request 112. The social media application 184 may receive, from the first user 102, the selection of the categories 126 and the criteria 114. The social media application 186 may then query the database 136 of the influencers 138. The social media application 186 may compare the selected categories to the subset of the categories to identify a match between the selected categories and the subset of the categories for the influencer profile A 140 (associated with the first influencer 186) and the influencer profile B 142 (associated with the second influencer 188). The social media application 186 may then compare the selected criteria to the subset of the criteria to identify another match between the selected criteria and the subset of the criteria for the influencer profile A 140 (associated with the first influencer 186) and the influencer profile B 142 (associated with the second influencer 188).

The social media application 186 may then display the influencer profile A 140 and the influencer profile B 142 to the first user 102. The social media application 186 may then receive, from the first user 102, the selection of the first influencer 186 to respond to the advice request 112 and may prompt the first influencer 186 to respond to the advice request 112. In response to receiving, from the first influencer 186, the response to the advice request 112, the social media application 186 may display the response to the first user 102.

Moreover, the computing device 400 may have additional features or functionality, and additional interfaces to facilitate communications between the basic configuration 402 and any desired devices and interfaces. For example, a bus/interface controller 430 is used to facilitate communications between the basic configuration 402 and data storage devices 432 via a storage interface bus 434. The data storage devices 432 may be one or more removable storage devices 436, one or more non-removable storage devices 438, or a combination thereof. Examples of the one or more removable storage devices 436 and the one or more non-removable storage devices 438 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 440 facilitates communication from various interface devices (e.g., one or more output devices 442, one or more peripheral interfaces 444, and one or more communication devices 466) to the basic configuration 402 via the bus/interface controller 430. Some of the one or more output devices 442 include a graphics processing unit 448 and an audio processing unit 450, which are configured to communicate to various external devices, such as a display or speakers, via one or more A/V ports 452. The one or more peripheral interfaces 444 may include a serial interface controller 454 or a parallel interface controller 456, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 458. Further, the one or more communication devices 466 may include a network controller 460, which is arranged to facilitate communication with one or more other computing devices 462 over a network communication link via one or more communication ports 464. The one or more other computing devices 462 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 406, the one or more removable storage devices 436, and the one or more non-removable storage devices 438 are examples of the computer-readable storage media. The computer-readable storage media is a tangible device that can retain and store instructions (e.g., program code) for use by an instruction execution device (e.g., the computing device 400). Any such, computer storage media is part of the computing device 400.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 404 of a general purpose computer, special purpose computer, or other programmable data processing apparatus (e.g., the computing device 400) to produce a machine, such that the instructions, which execute via the processor 404 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 400), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps for providing advice. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A computer system comprising one or more processors, one or more memories, and one or more computer-readable hardware storage devices, the one or more computer-readable hardware storage devices containing program code executable by the one or more processors via the one or more memories to implement a method for providing advice, the method comprising:
receiving, via a social media platform and from a user associated with a computing device, an advice request;
prompting, via the social media platform, the user to select categories associated with the advice request and criteria associated with influencers to respond to the advice request;
receiving, via the social media platform and from the user, the selection of the categories and the criteria;
querying, via the social media platform, a database of the influencers,
wherein the database of influencers comprises profiles associated with the influencers, and
wherein each of the profiles comprises a subset of the categories and a subset of the criteria;
in response to comparing the selected categories to the subset of the categories, identifying a match between the selected categories and the subset of the categories for a first profile associated with a first influencer of the influencers and a second profile associated with a second influencer of the influencers;
in response to comparing the selected criteria to the subset of the criteria, identifying another match between the selected criteria and the subset of the criteria for the first profile and the second profile;
displaying, via the social media platform, the first profile and the second profile to the user;
receiving, via the social media platform and from the user, a selection of the first influencer to respond to the advice request;
prompting, via the social media platform, the first influencer to respond to the advice request; and
in response to receiving, via the social media platform and from the first influencer, the response to the advice request, displaying the response to the user.

2. The computer system of claim 1, wherein the an advice request is for the user.

3. The computer system of claim 1, wherein the an advice request is for another user.

4. The computer system of claim 1,
wherein the response to the advice request is received via real-time feedback, and
wherein the real-time feedback comprises: a video component, an audio component, a textual component, and/or a graphical component.

5. The computer system of claim 1, wherein the advice comprises fashion advice and/or life advice.

6. The computer system of claim 1, wherein the categories associated with the advice request are selected from the group consisting of: a hairstyle category, an accessory category, an attire category, a footwear category, a relationships category, a makeup category, a friendships category, a career category, and a goals category.

7. The computer system of claim 1, wherein the criteria associated with the influencers to respond to the advice request are selected from the group consisting of: an age of the influencers, a gender of the influencers, a geographic location of the influencers, and an expertise status associated with the influencers.

8. The computer system of claim 7, wherein the expertise status is determined through a point system.

9. The computer system of claim 1, wherein the method further comprises:
in response to failing to receive, via the social media platform and from the first influencer, the response to the advice request, prompting, via the social media platform, the second influencer to respond to the advice request;
receiving, via the social media platform and from the second influencer, the response to the advice request; and
displaying the response to the user.

10. A method for providing fashion and/or life advice, the method comprising:
receiving, via a social media platform and from a user associated with a computing device, an advice request associated with the fashion and/or life advice;
prompting, via the social media platform, the user to select a category associated with the advice request and a predetermined expertise status associated with influencers to respond to the advice request;
receiving, via the social media platform and from the user, the selected category and the predetermined expertise status;
querying, via the social media platform, a database of the influencers,
wherein the database of influencers comprises a first profile associated with a first influencer and a second profile associated with a second influencer,
wherein the first profile comprises a subset of categories and a first expertise status,
wherein the second profile comprises another subset of categories and a second expertise status, and
wherein the first expertise level is greater than the second expertise level,
in response to comparing the selected category to the subset of the categories and to the other subset of the categories,
identifying a match between the selected category and the subset of the categories associated with the first profile; and
identifying another match between the selected category and the other subset of the categories associated with the second profile;
in response to comparing the predetermined expertise status to the first expertise status and the second expertise status,
identifying the first expertise status as exceeding the predetermined expertise status; and
identifying the second expertise status as failing to exceed the predetermined expertise status;
displaying, via the social media platform, the first profile to the user;
prompting, via the social media platform, the first influencer to respond to the advice request; and
in response to receiving, via the social media platform and from the first influencer, the response to the advice request, displaying the response to the user.

11. The method of claim 10, further comprising:
receiving feedback from the user based on the advice request.

12. The method of claim 11, wherein the feedback comprises a numerical rating of the first influencer and at least one of a video component, an audio component, a textual component, and a graphical component.

13. The method of claim 12, wherein the numerical rating of the first influencer correlates to a quantity of points.

14. The method of claim 13, further comprising:
increasing the first expertise status of the first influencer based on the quantity of points;
updating the first profile of the first influencer based on the modified first expertise status of the first influencer; and
transmitting the updated first profile to the database.

15. The method of claim 10, wherein the predetermined expertise status is set by the user.

16. A method for providing fashion advice, the method comprising:
receiving, via a social media platform and from a user associated with a computing device, an advice request associated with the fashion advice for another user;
prompting, via the social media platform, the user to select categories associated with the advice request and criteria associated with influencers to respond to the advice request;
receiving, via the social media platform and from the user, the selection of the categories and the criteria;
querying, via the social media platform, a database of the influencers,
wherein the database of influencers comprises profiles associated with the influencers, and
wherein each of the profiles comprises a subset of the categories and a subset of the criteria;
in response to comparing the selected categories to the subset of the categories, identifying a match between the selected categories and the subset of the categories for a first profile associated with a first influencer of the influencers and a second profile associated with a second influencer of the influencers;
in response to comparing the selected criteria to the subset of the criteria, identifying another match between the selected criteria and the subset of the criteria for the first profile and the second profile;
displaying, via the social media platform, the first profile and the second profile to the user;
receiving, via the social media platform and from the user, a selection of the first influencer to respond to the advice request;
prompting, via the social media platform, the first influencer to respond to the advice request; and
in response to receiving, via the social media platform and from the first influencer, the response to the advice request in real-time, displaying the response to the other user.

17. The method of claim 16, further comprising:
receiving real-time feedback from the other user based on the advice request, wherein the real-time feedback comprises a numerical rating of the first influencer and at least one of a video component, an audio component, a textual component, and a graphical component.

18. The method of claim 17, wherein the numerical rating of the first influencer correlates to a quantity of points.

19. The method of claim 18, further comprising:
increasing an expertise status of the first influencer based on the quantity of points;
updating the first profile of the first influencer based on the modified first expertise status of the first influencer; and
transmitting the updated first profile to the database.

20. The method of claim 16, wherein the categories associated with the advice request are selected from the group consisting of: hairstyles, accessories, attire, and footwear.
